(19) United States
(12) Patent Application Publication
(10) Pub. No.: US 2026/0238775 A1
(43) Pub. Date: Aug. 13, 2026

(54) SIGNALING OF CONSTRAINED DIRECTIONAL ENHANCEMENT FILTER

(71) Applicant: Tencent America LLC, Palo Alto, CA (US)

(72) Inventors: Ting-Lan LIN, Palo Alto, CA (US); Liang ZHAO, Palo Alto, CA (US); Madhu PERINGASSERY KRISHNAN, Palo Alto, CA (US); Tianqi LIU, Palo Alto, CA (US); Jayasingam ADHURAN, Palo Alto, CA (US); Shan LIU, Palo Alto, CA (US)

(21) Appl. No.: 19/373,579

(22) Filed: Oct. 29, 2025

Related U.S. Application Data
(60) Provisional application No. 63/756,721, filed on Feb. 10, 2025.

(51) Int. Cl. H04N 19/117; H04N 19/172; H04N 19/186; H04N 19/70

(52) U.S. Cl. CPC H04N 19/117; H04N 19/172; H04N 19/186; H04N 19/70

(57) ABSTRACT

An example method of video coding performed at a computing system includes receiving a video bitstream comprising a plurality of frames, including a current frame. The computing system parses a first frame-level syntax element indicating that a constrained directional enhancement filter (CDEF) is enabled for a first color component of the current frame. The computing system parses a second frame-level syntax element indicating that the CDEF is not enabled for a second color component of the current frame. The computing system parses reconstructs the current frame by applying the CDEF to only the first color component

### RELATED APPLICATIONS

This application claims priority to U.S. Provisional Patent Application No. 63/756,721 entitled “Improved Frame Level and Block Level Signaling of Constrained Directional Enhancement Filter (CDEF)” filed Feb. 10, 2025, which is hereby incorporated by reference in its entirety.

### TECHNICAL FIELD

The disclosed embodiments relate generally to video coding, including but not limited to systems and methods for signaling and applying constrained directional enhancement filters.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

The present disclosure describes various aspects of video coding including separate constrained directional enhancement filter (CDEF) signaling of luma and chroma components at a frame level. For example, the CDEF filtering may be separately signaled for individual color components (e.g., separate CDEF signaling of luma and chroma at a frame level). Frame-level control flags may indicate whether filtering is applied to the luma and chroma planes independently. When enabled, each plane may utilize distinct sets of primary and secondary filter strengths and may share or separately derive directional information. Such selective activation allows targeted artifact reduction on components (e.g., components that exhibit visible ringing or blocking) while reducing unnecessary filtering (e.g., on less perceptually sensitive planes), thereby improving compression efficiency and/or visual fidelity.

The present disclosure further describes selectively activating or bypassing CDEF filtering for individual coding blocks within a frame (e.g., overriding CDEF signaling at the frame level). At the frame level, respective enable flags and filter strength values may be signaled for the luma and chroma components. Each coding block then includes independent (binary) flags indicating whether CDEF is applied to the corresponding luma and chroma components. When a block-level flag is set, the decoding component may apply a CDEF using the globally signaled frame-level strength for that component, thereby eliminating the need to transmit local strength parameters. Allowing block-level overrides of a frame-level CDEF enable indicator reduces bitstream overhead, while allowing localized adaptation of filtering.

In accordance with some embodiments, a method of video decoding includes receiving a video bitstream comprising a plurality of frames, including a current frame. The method includes, parsing a first frame-level syntax element indicating that a CDEF is enabled for a first color component of the current frame. The method includes, parsing a second frame-level syntax element indicating that the CDEF is not enabled for a second color component of the current frame. The method includes, reconstructing the current frame by applying the CDEF to only the first color component.

In accordance with some embodiments, a method of video encoding includes, receiving video data comprising a plurality of frames, including a current frame. The method includes, signaling, via a video bitstream, a first frame-level syntax element indicating that a CDEF is enabled for a first color component of the current frame. The method includes, signaling, via the video bitstream, a second frame-level syntax element indicating that the CDEF is not enabled for a second color component of the current frame. The method includes, encoding the current frame.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates example in-loop filtering stages in accordance with some embodiments.

FIG. 4B illustrates example edge directions in CDEF in accordance with some embodiments.

FIG. 5A illustrates an example video decoding process in accordance with some embodiments.

FIG. 5B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes, amongst other things, video/image compression techniques that separately signal CDEFs for luma and chroma components (e.g., at a frame level). In some embodiments, a first frame-level syntax element indicating that the CDEF is enabled for a first color component of the current frame is parsed and a second frame-level syntax element indicating that the CDEF is not enabled for a second color component of the current frame is parsed. The current frame is reconstructed by applying the CDEF to only the first color component (e.g., when CDEF is enabled for the first color component but disabled for the second color component) or to only the second color component (e.g., when CDEF is disabled for the first color component but enabled for the second color component). Providing separate frame-level enable flags for the CDEF for luma and chroma components improves overall coding efficiency by allowing selective application of the filter where it yields compression gains. Independent control of luma and chroma filtering enables the encoder to disable processing for components that contribute minimally to prediction accuracy, thereby reducing computational complexity and associated signaling overhead.

The present disclosure describes, amongst other things, signaling of CDEFs in video coding, such as enabling separate control of luma and chroma components at both frame and block levels. By allowing independent enablement flags, distinct filter strengths, and/or variable precision for luma and chroma, fine-grained adaptation of in-loop filtering may be provided to the perceptual and statistical characteristics of each color component. Block-level override flags enable further localized activation or bypassing of CDEF, reducing unnecessary filtering in regions where it is not beneficial. These techniques collectively reduce bitstream overhead, enhance coding efficiency, and improve visual fidelity by targeting artifact reduction where most needed, while minimizing computational complexity and signaling for less sensitive components.

### Example Systems and Devices

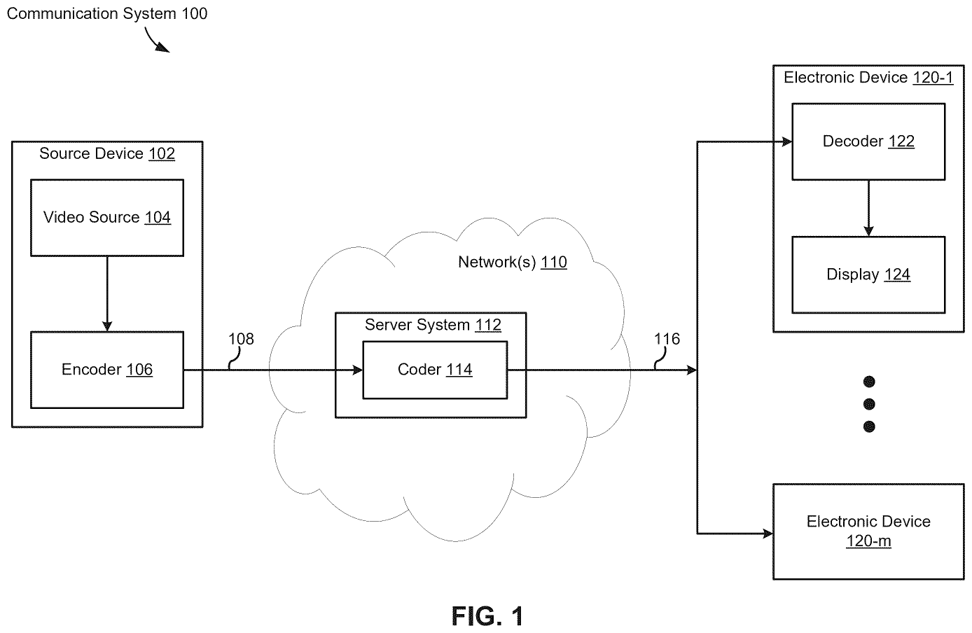

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

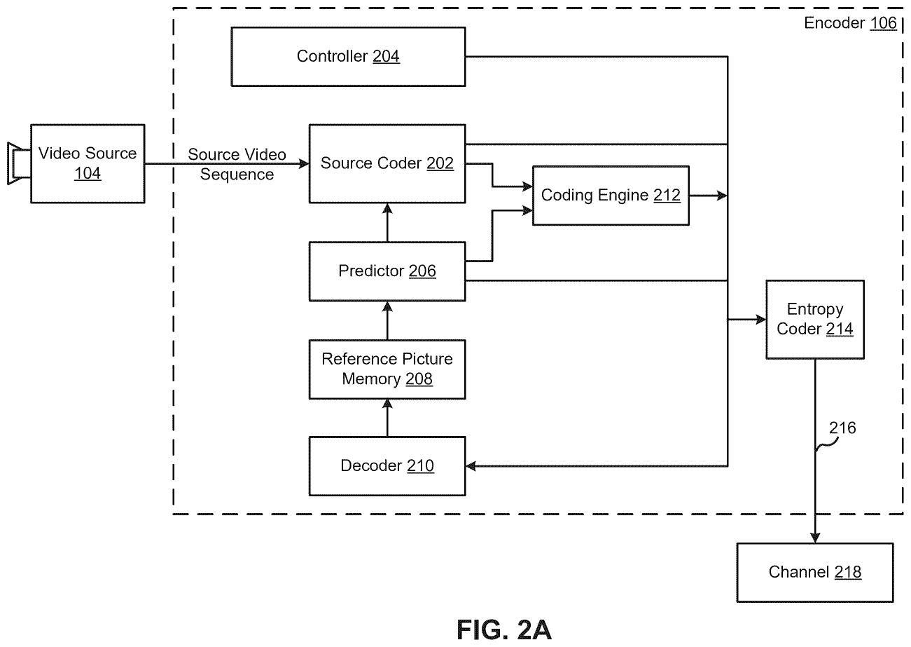

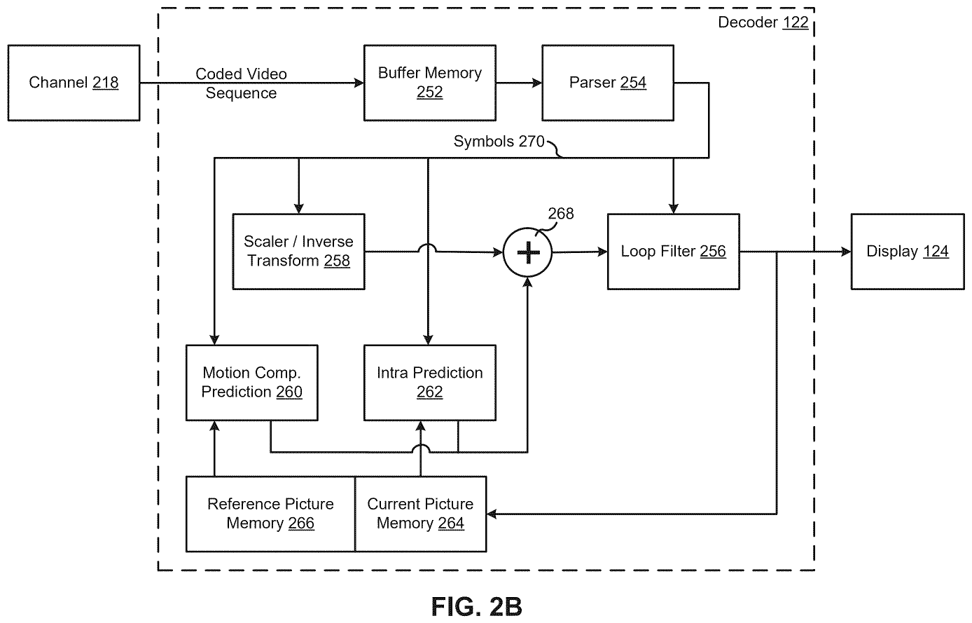

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

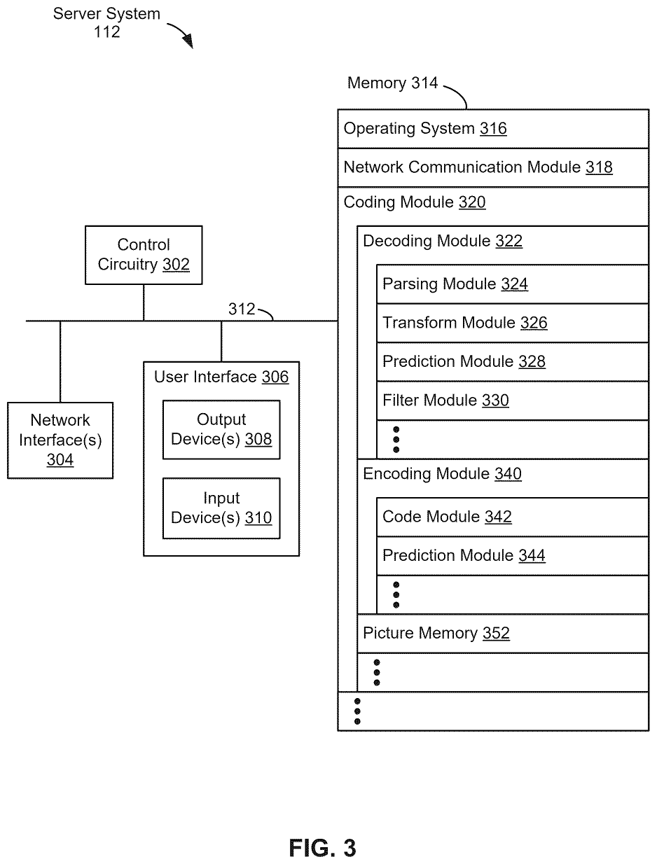

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). The techniques described below include separately signaling CDEFs for luma and chroma components (e.g., a at frame level) and signaling different block level (e.g., 64×64 block level) override indicators.

In-loop filtering and in-loop filter stages are described next. In video coding, in-loop filtering refers to a sequence of post-processing operations applied to reconstructed frames within the encoding and decoding loop to improve visual quality and coding efficiency. These filters—such as the deblocking filter, the CDEF, and the loop restoration filter—reduce compression artifacts, including blocking, ringing, and edge discontinuities, that arise from block-based transform and quantization. The filtering is performed on reconstructed pixels (e.g., before the frame is stored as a reference for inter prediction, where the subsequent predictions are derived from visually enhanced content (e.g., enhanced as a result of the filtering)). Each stage (e.g., each filter in the in-loop filtering pipeline) modifies pixel values based on local statistics, edge directionality, and/or estimated noise characteristics, providing artifact suppression while preserving fine image details and directional structures.

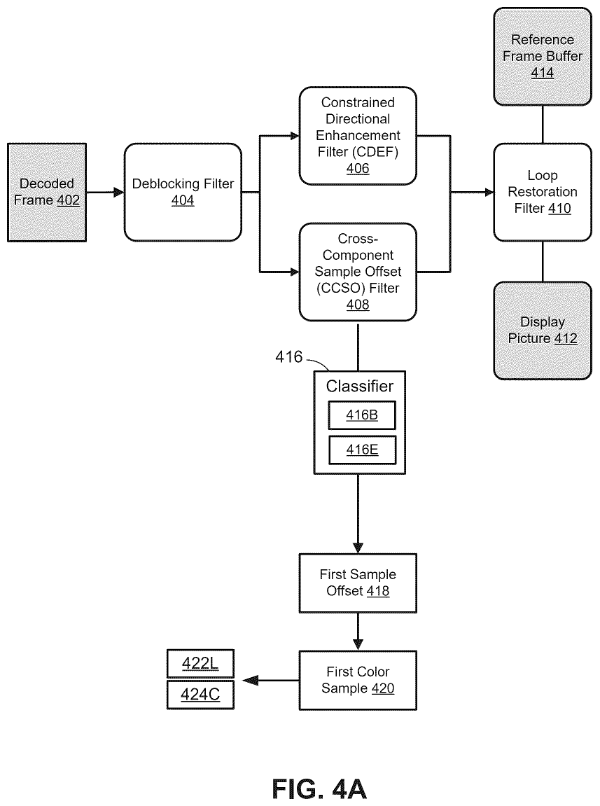

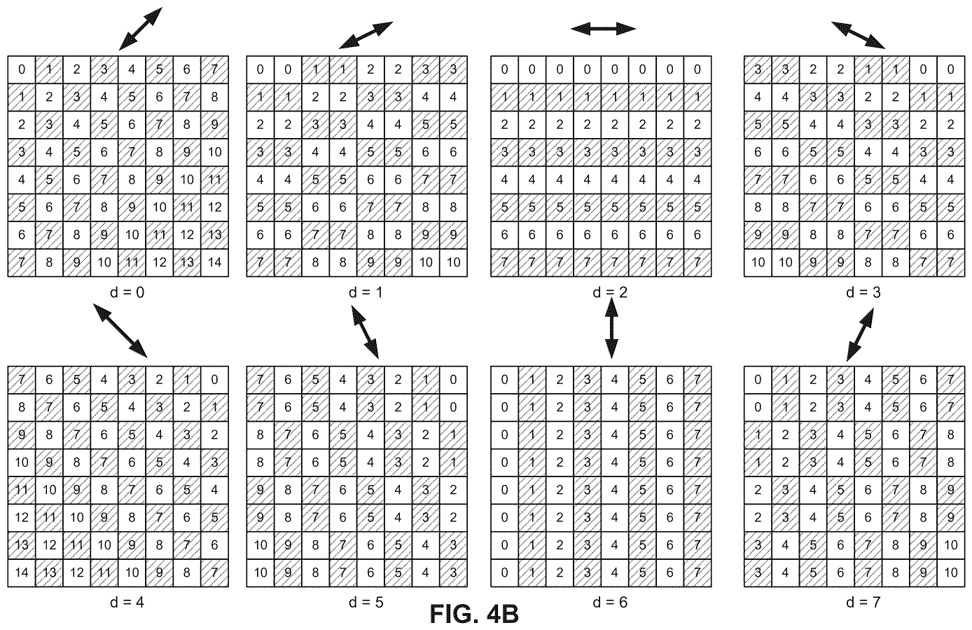

FIG. 4A illustrates example in-loop filtering stages in accordance with some embodiments. In the example of FIG. 4A, the in-loop filtering stages applied to the decoded frame 402 include a deblocking filter 404, a CDEF 406, a CCSO filter 408 and a loop restoration filter 410. In some embodiments, the filtered output frame is used as a reference frame for later frames (e.g., stored in a reference frame buffer 414). In some embodiments, a normative film grain synthesis stage is also applied to generate a corresponding displayed picture 412. Unlike the in-loop filter stages, the results of the film grain synthesis stage (e.g., an out-of-loop filter) does not influence the prediction for subsequent frames. The loop filtering methods may include any filtering process applied on the reconstructed samples (e.g., after adding residual to the prediction), including wiener loop filtering, cross-component filtering via the CCSO filter 408 and the CDEF 406.

The deblocking filter 404 is an in-loop filtering process configured to reduce visible discontinuities that occur along block boundaries as a result of block-based transform coding and quantization. In some embodiments, the deblocking filter 404 is applied across the transform block boundaries to remove block artifacts caused by the quantization error. The filter operates adaptively along horizontal and vertical edges of coded blocks, detecting discontinuities in pixel intensity across block boundaries and selectively smoothing those edges when the difference exceeds a context-dependent threshold. By reducing blocking artifacts in reconstructed frames prior to their use as reference frames for inter prediction, the deblocking filter improves both subjective visual quality and overall coding efficiency.

In some embodiments, filtering strength and direction are determined based on local coding parameters, such as quantization level, prediction mode, and motion information, to preserve true image edges while attenuating artificial ones. In some embodiments, a filter length is determined based on the minimum transform block sizes on both sides. In some embodiments, finite impulse response (FIR) filters (e.g., low-pass filters) are used by the deblocking filter 404. Edge detection may be used to disable the deblocking filter at transitions that contain a high variance signal (e.g., to avoid blurring an actual edge in the original image). In this way, a deblocking filtering method may be applied on reconstructions samples located close to block boundaries. The block boundaries may include a transform block boundary, a motion compensation block boundary, a coding block boundary, and/or a fixed block size boundary.

The CDEF 406 is an in-loop adaptive filtering process designed to suppress ringing and other directional artifacts that remain after block-based reconstruction. For each 8×8 block of reconstructed pixels, the filter identifies or determines a dominant edge direction based on local pixel gradients and applies directional filtering aligned the identified direction. For example, CDEF 406 applies filtering along the identified direction and to a lesser degree along directions rotated 45 degrees from the identified direction. In some embodiments, the filter strengths are signaled explicitly, which allows a high degree of control over the blurring. CDEF 406 uses weighted taps along primary and secondary directions, with a non-linear constraint function that limits the influence of pixels exhibiting large intensity differences, thereby preserving strong edges and textures. By enhancing structural coherence while avoiding over-smoothing, CDEF 406 improves perceptual quality and provides cleaner, directionally consistent reference frames for subsequent inter prediction stages.

In some embodiments, a CCSO filtering method uses (e.g., by applying CCSO filter 408) a co-located reconstructed sample and neighboring reconstructed samples from a first color component as input, to perform filtering of the current reconstruction sample of a second color component. In some embodiments, a CCSO filtering method may use (e.g., by applying CCSO filter 408) the co-located reconstructed sample and its neighboring reconstructed samples from a first color component as input, to derive an offset value that is added on the current sample of a second color component to adjust its reconstruction value. The first color component may refer to a luma color component, and the second color component may refer to a chroma color component. The first color component and second color component may be the same color component (e.g., a luma component). The CCSO filter 408 may produce offset values, which are added to the reconstructed samples of the luma and chroma components to reduce reconstruction error. In some embodiments, the CCSO filter 408 operates concurrently with CDEF 406. For example, the reconstructed samples following deblocking 504 may be used as input for both the CDEF 406 and the CCSO filter 4084

In some embodiments, the loop restoration filter 410 is applied to reconstructed pixels after any prior in-loop filtering stages (e.g., the deblocking filter 404, the CDEF 406, and/or CCSO filter 408). The loop restoration filter 410 may be applied to loop restoration units (LRU), e.g., 64×64, 128×128, and/or 256×256 pixel blocks. Bypass filtering, a wiener filter (e.g., a wiener loop filtering method), and/or a self-guided filter may be applied to each LRU independently. A wiener loop filtering method may use a linear weighted sum of the current reconstruction sample and multiple spatially neighboring reconstruction samples as input to derive a modified value for the current reconstruction sample as the output.

CCSO is designed for improved loop filtering on both luma and chroma components. In some embodiments, the filtering process of CCSO involves three main steps. First, the current reconstructed luma samples (e.g., the output of the deblocking process) are classified using classifiers 416. There are two types of classifiers: the edge-offset (EO) classifier 416E and the band-offset (BO) classifier 416B. These classifiers can operate jointly or individually based on indicators signaled at the frame level. Second, the class associated with the current luma sample is used as an index to fetch offset values from a lookup table (LUT), which is determined at the frame level with entries selected from a limited number of predefined values. This LUT is shared across the entire frame. Finally, the derived offset values using the LUT and class index are added to the corresponding luma and chroma components. A filter unit-level on/off flag (non-overlapped 256×256 luma samples) is signaled to indicate whether CCSO filtering is applied for the associated filter unit.

With continued reference to FIG. 4A, in some embodiments associated with band offset classification, the CCSO filtering method comprises a band offset classifier 416B. Based on the band offset classifier 416B, the decoder 122 may determine that a set of target luma samples includes a first luma sample and one or more neighboring luma samples. The set of target luma samples are provided to a quantizer, and used to generate one or more quantized values, which are further applied by the band offset classifier 416B to classify the first color sample 520. In some embodiments associated with edge offset classification, the CCSO filtering method comprises an edge offset classifier 416E. Based on the edge offset classifier 416E, the decoder 122 may determine that a set of target luma samples includes a first luma sample and one or more neighboring luma samples. Difference values of the neighboring luma samples and the first luma sample are provided to a quantizer, and used to generate one or more quantized values, which are further applied by the edge offset classifier 416E to classify the first color sample 420. In some embodiments, the first color sample 420 is classified, e.g., by the classifier 416, based on the quantized values to determine the first sample offset 418 of the first color sample 420. The first color sample 420 is adjusted based on the first sample offset 418 of the first color sample 420, thereby enabling reconstruction of the current image frame. In some embodiments, the first color sample 420 includes a first chroma sample 424C that is co-located with the first luma sample 422L in the current image frame, and the first chroma sample 424C is adjusted based on the first sample offset 518. Alternatively, in some embodiments, the first color sample 420 is the first luma sample 422L, and the first luma sample 424C is adjusted based on the first sample offset 418.

As described above, CCSO is an edge preserving loop filter that uses the reconstructed samples to compute the sample offsets of luma and/or chroma components. In some embodiments, only the luma samples located in positions defined by the filter shape are used to compute the offset of the chroma component or the luma component. In some embodiments, the offset value may be derived by three steps. In the first step, values are derived using the co-located reconstructed sample and its neighboring reconstructed samples from a first color component. For example, one or multiple difference values between the co-located reconstructed sample and its neighboring reconstructed samples from a first color component. The positions of the neighboring reconstructed samples are selected based on a given filter shape. The filter shape index may be signaled in a frame header. In the second step, the derived values are quantized using a scalar quantizer. A scalar quantizer is specified by quantization intervals and quantization levels, a quantization interval is defined to be the range of values assigned to the same integer, and a quantization level is defined as the integer value to which all values within a quantization interval are assigned. In the third step, given the quantized derived values (or quantization level) as a classifier, an offset value may be derived based on the value of given classifier. For example, the combinations of quantized values are used as indices to a selected look-up table, and the output of the selected look-up table is the offset value.

As mentioned above, CDEF 406 filter is a non-linear in-loop filter to be performed on coded video after deblocking filter (e.g., to remove ringing/banding effect). As explained above, for each 8×8 block, CDEF 406 first performs direction detection, followed by filtering. The direction detection is performed on reconstructed pixels by computing against D direction patterns. In some embodiments, in CDEF 406, there are 8 possible predefined edge directions, corresponding to different angular slope (e.g., 0°, 45°, 90°, 135°, 22.5°, 67.5°, 112.5°, and 157.5°), as illustrated in FIG. 4B. To determine the dominant direction, CDEF 406 projects pixel intensities onto a set of lines along direction d; computes the sum of squared differences (SSD) between actual pixels and the mean value along each projected line; and selects as the block's dominant direction the direction that minimizes the SSD (or equivalently maximizes directional correlation). In some embodiments, because the pixel directions are not continuous, the selected direction is encoded as an integer from 0 to 7. This index is later used by the CDEF 406 filter to determine which neighboring pixels to include, and how to weight them (e.g., stronger weights along the edge direction, weaker across it). After determining the dominant edge direction of an 8×8 block, CDEF applies two sets of directional filters: (i) a primary filter, aligned along the detected dominant direction, and a secondary filter, oriented diagonally (±45°) relative to the dominant direction. For direction d (e.g., the identified dominant direction), a set of neighboring pixels corresponding to direction d are used for primary filter, and another set of neighboring pixels corresponding to 45° away from direction d are used for secondary filter. The filter coefficients and location of neighbors are associated with d. Primary strength and secondary strength (and a damping factor) are used in the computation of the nonlinear filtering on the difference between current pixel and a neighboring pixel for primary and secondary filter, and the result of the nonlinear filter is to be multiplied with the associated filter coefficient, and summed together with the original pixel, to be the final filtered pixel. The primary strength and secondary strength are combined into a strength for signaling, which is optionally 6-bits, deriving primary strength by strength/4 in range of 0-15, and deriving secondary strength by strength %4 in range of 0, 1, 2, 3. All the 8×8 blocks within a 64×64 block share one strength. At frame-level, by considering all 64×64 blocks in a frame, a set of best strengths are found for the current frame and saved in cdef_strengths array for luma, and cdef_uv_strengths array for chroma, where these two arrays are of the same length. Each 64×64 block then uses a single index to select one CDEF strength from cdef_strengths array, and one CDEF uv strength from cdef_uv_strengths array.

For signaling, at frame level, a 1-bit cdef_frame_enable is signaled. If cdef_frame_enable is 1, signal 2-bit damping factor, and a 2-bit cdef_bit indicating the length of cdef_strengths array (and cdef_uv_strengths array) to be 2^{(cdef_bit)} The elements in cdef_strengths array and cdef_uv_strengths array are then signaled (each element is 6-bit), as in FIG. 1.

Figure 1. CDEF frame-level signaling

| | |
|---|---|
| cdef_frame_enable | (1) |
| if (!cdef_frame_enable) | |
| return | |
| cdef_damping | (2) |
| cdef_bits | (2) |
| nb_cdef_strengths = 1 << cdef_bits | |
| for i=0 to nb_cdef_strengths do | |
| cdef_strengths[i] | (6) |
| cdef_uv_strengths[i] | (6) |

If cdef_frame_enable is 1, at 64×64 block level, the index to the best CDEF strength (and CDEF uv strength) in the cdef_strengths array (and cdef_uv_strengths array) is signaled in cdef_bit bits, as in FIG. 2.

Figure 2. CDEF 64 × 64 block-level signaling

| | |
|---|---|
| sb_cdef_strength | (cdef_bits) |

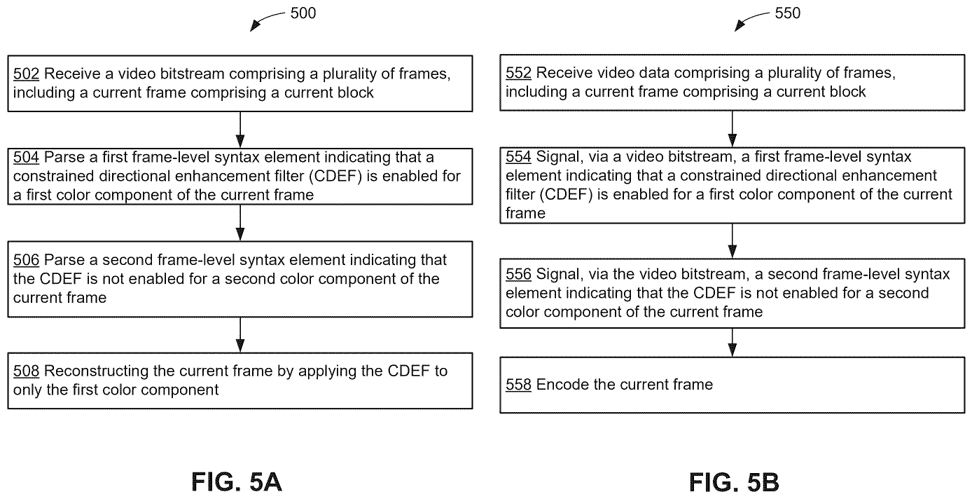

FIG. 5A is a flow diagram illustrating a method 500 of decoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The computing system receives (502) a video bitstream comprising a plurality of frames, including a current frame. The computing system (504) parses a first frame-level syntax element indicating that a CDEF is enabled for a first color component of the current frame. The computing system (506) parses a second frame-level syntax element indicating that the CDEF is not enabled for a second color component of the current frame. The computing system (508) reconstructs the current frame by applying the CDEF to only the first color component. In this way, at frame level, a luma CDEF enable flag and a chroma CDEF enable flag may be signaled separately, thereby reducing signaling overhead by not having to separately signal the parameters for one of the color components.

In some embodiments, at a frame level, the flags to enable/disable luma and chroma CDEF are signaled separately. In some embodiments, the U and V channels for chroma component share one CDEF on/off flag. In some embodiments, the chroma channels U and V have separate CDEF on/off flags.

In some embodiments, the CDEF enabling flag for chroma component depends on the CDEF enabling flag for luma component. In some embodiments, the CDEF enabling flag for chroma component is only signaled when the CDEF signaling flag for luma component is on (e.g., enabled). In some embodiments, the CDEF enabling flag for luma component is used as context for signaling the CDEF enabling flag for chroma component.

In some embodiments, at frame level, the CDEF damping factors for luma and chroma are signaled separately. In some embodiments, the number of bits used for signaling luma and chroma damping factors are different. In one example, the luma CDEF damping factors are signaled by 2 bits whereas the chroma damping factors are signaled by 1 bit.

In some embodiments, the number of bits for signaling the cdef_strengths array (number of presets for luma CDEF) and cdef_uv_strengths array (number of presets for chroma CDEF) are signaled separately for luma and chroma components. In one example, the 64×64 block level signaling for luma CDEF strength index are different from the chroma CDEF strength index.

In some embodiments, at frame level, the cdef_bit are different for luma and chroma components, so that the lengths of cdef_strengths array and cdef_uv_strengths array are different, and so that the 64×64 block-level indexes to cdef_strengths array and cdef_uv_strengths array are signaled separately. In one example, the cdef_bit for luma may be 3 bits, so the cdef_strengths array is of length 23 and 64×64 block level uses 3 bits to signal the index to the cdef_strengths array, whereas the cdef_bit for chroma may be 2 bits, so the cdef_uv_strengths array is of length 2² and 64×64 block level uses 2 bits to signal the index to the cdef_uv_strengths array.

In some embodiments, at frame level, the precision (the allowed value of CDEF strength) of each CDEF strength and CDEF uv strength can be of different bits, providing different precision on primary strength and secondary strength for luma and chroma. In one example, the precision of each CDEF strength for luma is 6 bit, deriving primary strength by strength/4 in range of 0-15, and deriving secondary strength by strength %4 in range of 0, 1, 2, 3, whereas the precision of each cdef_uv_strength is 4 bit, deriving primary strength by strength/4 in range of 0, 1, 2, 3, and deriving secondary strength by strength %4 in range of 0, 1, 2, 3.

In some embodiments, when luma (chroma) CDEF is enabled at frame level, the 64×64 block level signals a flag for luma (chroma) 64×64 block to disable CDEF. In some embodiments, the 64×64 block level signals a flag for luma (chroma) block to disable CDEF, based on whether the blocks in the 64×64 block skip the transform. In some embodiments, the 64×64 block level signals a flag for luma (chroma) block to disable CDEF, based on whether the blocks in the 64×64 block reference to frames that enables frame level CDEF. In some embodiments, the 64×64 block level signals a flag for luma (chroma) block to disable CDEF, if all the blocks in the 64×64 block skip the transform, and the references of the blocks in the 64×64 block enable frame level CDEF

In some embodiments, the strength in cdef_strengths array and cdef_uv_strengths are first coded to indicate whether each is 0. When not, code it with other non-zero symbols.

In some embodiments, a strength 0 must be in cdef_strengths array and cdef_uv_strengths array for luma and chroma in a 64×64 block to turn off CDEF filtering.

In some embodiments, the number of directions of a block are based on 8×8 luma, 4×4 chroma U, and 4×4 chroma V. In one example, the number of directions are 8 for an 8×8 luma block, and 4 for 4×4 chroma. In one example, the number of directions are 4 for an 8×8 luma block and for 4×4 chroma.

In some embodiments, the directions for each 8×8 luma and 4×4 chroma U and 4×4 chroma V are differently decided.

In some embodiments, the block signaling unit is up to 128×128. In some embodiments, a flag is signaled to indicate whether split blocks within this block have the same index. When so, signal CDEF syntaxes for this block. When not, repeat this procedure.

In some embodiments, at 64×64 block level, luma CDEF enable flag and chroma CDEF enable flag are signaled separately.

In some embodiments, when luma CDEF is enabled at frame level, one specific luma strength is signaled. At 64×64 block level, a flag of luma CDEF enable is signaled; when enabled, the specific luma strength is used.

In some embodiments, when chroma CDEF is enabled at frame level, one specific chroma strength is signaled. At 64×64 block level, a flag of chroma CDEF enable is signaled; when enabled, the specific chroma strength is used.

FIG. 5B is a flow diagram illustrating a method 550 of encoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 550 is performed by a same system as the method 500 described above.

The system receives (552) video data (e.g., a source video sequence) comprising a plurality of frames, including a current frame. The system signals (554), via a video bitstream, a first frame-level syntax element indicating that a CDEF is enabled for a first color component of the current frame. The system signals (556), via the video bitstream, a second frame-level syntax element indicating that the CDEF is not enabled for a second color component of the current frame. The system encodes (558) the current frame. As described previously, the encoding process may mirror the decoding processes described herein (e.g., CDEF signaling, parsing, and application). For brevity, those details are not repeated here.

Although FIGS. 5A and 5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

(A1) In one aspect, some embodiments include a method (e.g., the method 500) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes receiving a video bitstream (e.g., a coded video sequence) comprising a plurality of frames, including a current frame. The method includes, parsing a first frame-level syntax element indicating that a CDEF is enabled for a first color component of the current frame. The method includes, parsing a second frame-level syntax element indicating that the CDEF is not enabled for a second color component of the current frame. The method includes, reconstructing the current frame by applying the CDEF to only the first color component. In this way, at a frame level, a luma CDEF enable flag and a chroma CDEF enable flag may be signaled separately.

(A2) In some embodiments of A1, the first frame-level syntax element corresponds to a luma CDEF enablement flag, and the second frame-level syntax element corresponds to a chroma CDEF enablement flag. For example, at frame level, the flag to enable/disable luma and chroma CDEF can be signaled separately.

(A3) In some embodiments of A1 or A2, the second frame-level syntax element indicates that the CDEF is disabled for two different color components. For example, the U and V channels for chroma component may share one CDEF on/off flag.

(A4) In some embodiments of any of A1-A3, the method includes parsing a third frame-level syntax element indicating that the CDEF is disabled for a third color component the current frame. For example, the chroma channels U and V can have separate CDEF on/off flags.

(A5) In some embodiments of any of A1-A4, the second frame-level syntax element indicates whether a CDEF enablement state for the second color component is the same as a CDEF enablement state for the first color component. For example, the CDEF enabling flag for chroma component may depend on the CDEF enabling flag for luma component. In some embodiments, the CDEF enablement flag for chroma component is only signaled when the CDEF enablement flag for luma component indicates that the CDEF is enabled (e.g., thereby reducing signaling overhead).

(A6) In some embodiments of any of A1-A5, a context for entropy decoding the second frame-level syntax is based on a value of the first frame-level syntax element. For example, the CDEF enabling flag for luma component may be used as context for signaling the CDEF enabling flag for the chroma component.

(A7) In some embodiments of any of A1-A6, the method includes parsing one or more color-specific syntax elements to determine one or more parameters for applying the CDEF to the first color component. In some embodiments, in accordance with a determination that separate CDEFs are applied to luma and chroma components, identifying different parameters for applying the separate CDEFs to the luma and chroma components. In some embodiments, a single enablement flag is used for both color components, but separate parameters are signaled/parsed/used for the different color components.

(A8) In some embodiments of A7, the one or more parameters comprise a damping factor for applying the CDEF to the first color component. For example, at frame level, the CDEF damping factors for luma and chroma may be signaled separately.

(A9) In some embodiments of A7 or A8, the one or more parameters correspond to a CDEF strength array for applying the CDEF to the first color component. In some embodiments, two CDEF strength arrays are signaled with differing numbers of bits. For example, the number of bits for signaling the cdef_strengths array (number of presets for luma CDEF) and cdef_uv_strengths array (number of presets for chroma CDEF) may be signaled separately for luma and chroma components. In some embodiments, the color-specific syntax elements indicate whether a CDEF strength is zero, and when the CDEF strength is non-zero, indication of the CDEF strength array. For example, the strength in cdef_strengths array and cdef_uv_strengths can be first coded whether it is 0. When not, code it with other non-zero symbols. In some embodiments, a CDEF strength of zero is used to determine whether the CDEF is enabled (e.g., a CDEF strength of zero indicates that the CDEF is disabled). As an example, a strength 0 must be in cdef_strengths array and cdef_uv_strengths array for luma and chroma in a 64×64 block to turn off CDEF filtering. For example, the CDEF strength of zero/non-zero may be used in place of an enablement flag

(A10) In some embodiments of any of A7-A9, the one or more parameters correspond to a CDEF bit for applying the CDEF to the first color component. For example, at frame level, the cdef_bit can be different for luma and chroma, so that the lengths of cdef_strengths array and cdef_uv_strengths array are different, and so that the 64×64 block-level indexes to cdef_strengths array and cdef_uv_strengths array are signaled separately. An example, the cdef_bit for luma can be 3 bits, so the cdef_strengths array is of length 23 and 64×64 block level use 3 bits to signal the index to the cdef_strengths array, whereas the cdef_bit for chroma can be 2 bits, so the cdef_uv_strengths array is of length 2² and 64×64 block level use 2 bits to signal the index to the cdef_uv_strengths array. In some embodiments, reducing the number of presets needed for chroma-heavy content, coding efficiency is improved.

(A11) In some embodiments of any of A1-A10, when the CDEF is enabled for the first color component, the method includes parsing a first indicator indicating a CDEF parameter for the first color component, wherein the first indicator has a first number of bits; and when the CDEF is enabled for the second color component, the method includes parsing a second indicator indicating a CDEF parameter for the second color component, wherein the second indicator has a second number of bits, different than the first number of bits. In some embodiments, the CDEF parameters are damping factors. For example, the number of bits used for signaling luma and chroma damping factors may be different. As an example, the luma CDEF damping factors can be signaled by 2 bits whereas the chroma damping factors can be signaled by 1 bit. In some embodiments, the CDEF parameters are indices for strength arrays. In some embodiments, the indices are for different sets of strength arrays. For example, the 64×64 block level signaling for luma CDEF strength index can be different with the chroma CDEF strength index. In some embodiments, the first indicator and the second indicator are conditionally signaled/parsed when the CDEF is enabled for the corresponding component. In some embodiments, allowing different bit lengths for signaling luma and chroma damping factors enables finer control for the component that has greater impact on overall coding efficiency, while reducing unnecessary precision for the less perceptually or statistically significant component, thereby reducing overall bitstream overhead.

(A12) In some embodiments of any of A1-A11, when the CDEF is enabled for the first color component, the method includes parsing a first indicator indicating a CDEF parameter for the first component, where the CDEF parameter for the first component has a first precision; and when the CDEF is enabled for the second color component, parsing a second indicator indicating a CDEF parameter for the second component, wherein the CDEF parameter for the second component has a second precision, different than the first precision. For example, at frame level, the precision (the allowed value of CDEF strength) of each CDEF strength and CDEF uv strength can be of different bits, providing different precision on primary strength and secondary strength for luma and chroma. As an example, the precision of each CDEF strength for luma can be 6 bit, deriving primary strength by strength/4 in range of 0-15, and deriving secondary strength by strength %4 in range of 0, 1, 2, 3, whereas the precision of each cdef_uv_strength can be 4 bit, deriving primary strength by strength/4 in range of 0, 1, 2, 3, and deriving secondary strength by strength %4 in range of 0, 1, 2, 3. By providing different precision (i.e., different bit depths or quantization step sizes) for primary and secondary CDEF strengths across luma and chroma components reduces bitstream overhead while providing more efficient rate-distortion optimization. For example, allocating higher precision to the luma primary strength allows finer control of dominant directional filtering, which has greater impact on coding efficiency, while using lower precision for secondary or chroma strengths reduces signaling bits where perceptual or predictive sensitivity is lower.

(A13) In some embodiments of any of A1-A12, the method includes, for a block in the current frame, determining whether the CDEF is enabled for the block by parsing a block-level syntax element that indicates whether to override the first frame-level syntax element. For example, when a luma (and/or chroma) CDEF is enabled at frame level, the 64×64 block level can signal a flag for a luma (and/or chroma) 64×64 block to disable CDEF. In some embodiments, the CDEF is selectively enabled for each block in a frame based on respective block-level overrides for a frame-level CDEF indicator. In some embodiments, the method further comprises, when the CDEF is enabled for the block, determining whether each sub-block of a block uses the same CDEF parameters. For example, a flag can be signaled to indicate whether split blocks within this block have the same index. When so, signal CDEF syntaxes for this block. When not, repeat this procedure. For example, when the indicator is equal to 1, a shared set of CDEF syntax is used for subblocks; and, when the indicator is equal to 0, different sets of CDEF syntaxes are used for the respective subblocks. In some embodiments, when the CDEF is enabled for the block, parameters signaled at a frame level are used to apply the CDEF to the block. For example, when luma CDEF is enabled at frame level, one specific luma strength is signaled. At 64×64 block level, a flag of luma CDEF enable is signaled; when enabled, the specific luma strength is used. As another example, when chroma CDEF is enabled at frame level, one specific chroma strength is signaled. At 64×64 block level, a flag of chroma CDEF enable is signaled; when enabled, the specific chroma strength is used. In some embodiments, allowing block-level overrides of a frame-level CDEF enable indicator, such that CDEF filtering may be selectively activated or bypassed for individual coding blocks within a frame provides localized control of in-loop filtering. Using block-level override flags rather than separate per-block filter parameter signaling reduces bitstream overhead.

(A14) In some embodiments of A13, the block-level syntax element is conditionally signaled and parsed based on one or more attributes of the block. In some embodiments, the one or more attributes comprise a transform skip attribute. For example, the 64×64 block level can signal a flag for luma (chroma) block to disable CDEF, based on whether the blocks in the 64×64 block skip the transform. In some embodiments, the one or more attributes correspond to whether CDEF is enabled for reference frames for the block. For example, the 64×64 block level can signal a flag for luma (chroma) block to disable CDEF, based on whether the blocks in the 64×64 block reference to frames that enables frame level CDEF. As an example, the 64×64 block level can signal a flag for luma (chroma) block to disable CDEF, if all the blocks in the 64×64 block skip the transform, and the references of the blocks in the 64×64 block enable frame level CDEF.

(A15) In some embodiments of any of A1-A14, the method includes determining a direction for the CDEF applied to the first color component based on a 4×4 block. For example, the number of directions of a block can be based on 8×8 luma, 4×4 chroma U and 4×4 chroma V. As an example, the number of directions can be 8 for an 8×8 luma block, and 4 for 4×4 chroma. As another example, the number of directions can be 4 for a 8×8 luma block and for 4×4 chroma. In some embodiments, a first technique is used to determine the direction for the CDEF applied to the first color component, and a second technique is used to determine the direction for the CDEF applied to the second color component, the second technique being different than the first technique. As an example, the direction for each 8×8 luma and 4×4 chroma U and 4×4 chroma V can be differently decided.

(A16) In some embodiments of any of A1-A15, the method includes determining a unit size for the CDEF applied to the first color component. For example, the block signaling unit can be up to 128×128. In some embodiments, the unit size for each CDEF is based on a superblock size (e.g., is the same as the superblock size).

(B1) In another aspect, some embodiments include a method (e.g., the method 550) of video encoding. In some embodiments, the method is performed at a computing system (e.g., the server system 112) having memory and control circuitry. In some embodiments, the method is performed at a coding module (e.g., the coding module 320). The method includes: (i) receiving video data (e.g., a source video sequence) comprising a plurality of frames, including a current frame; (ii) signaling, via a video bitstream, a first frame-level syntax element indicating that a CDEF is enabled for a first color component the current frame; (iii) signaling, via the video bitstream, a second frame-level syntax element indicating that the CDEF is not enabled for a second color component the current frame; and (iv) encoding the current frame. In some embodiments, the method further includes transmitting encoded information for the current frame in the video bitstream.

(B2) In some embodiments of B1, the first frame-level syntax element corresponds to a luma CDEF enablement flag, and the second frame-level syntax element corresponds to a chroma CDEF enablement flag.

(B3) In some embodiments of B1 or B2, the method includes encoding side analogous of the techniques and features described above with respect to any of A1-A16.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A16, and B1-B3).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A16, and B1-B3 above). In some embodiments, a memory or non-transitory computer-readable storage medium stores a video bitstream including any of the features (e.g., syntax and encoded information) disclosed herein.

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of frames, including a current frame;
parsing a first frame-level syntax element indicating that a constrained directional enhancement filter (CDEF) is enabled for a first color component of the current frame;
parsing a second frame-level syntax element indicating that the CDEF is not enabled for a second color component of the current frame; and
reconstructing the current frame by applying the CDEF to only the first color component.

2. The method of claim 1, wherein the first frame-level syntax element corresponds to a luma CDEF enablement flag, and wherein the second frame-level syntax element corresponds to a chroma CDEF enablement flag.

3. The method of claim 1, wherein the second frame-level syntax element indicates that the CDEF is disabled for two different color components.

4. The method of claim 1, further comprising parsing a third frame-level syntax element indicating that the CDEF is disabled for a third color component of the current frame.

5. The method of claim 1, wherein the second frame-level syntax element indicates whether a CDEF enablement state for the second color component is the same as a CDEF enablement state for the first color component.

6. The method of claim 1, wherein a context for entropy decoding the second frame-level syntax element is based on a value of the first frame-level syntax element.

7. The method of claim 1, further comprising parsing one or more color-specific syntax elements to determine one or more parameters for applying the CDEF to the first color component.

8. The method of claim 7, wherein the one or more parameters comprise a damping factor for applying the CDEF to the first color component.

9. The method of claim 7, wherein the one or more parameters correspond to a CDEF strength array for applying the CDEF to the first color component.

10. The method of claim 7, wherein the one or more parameters correspond to a CDEF bit for applying the CDEF to the first color component.

11. The method of claim 1, further comprising:
when the CDEF is enabled for the first color component, parsing a first indicator indicating a CDEF parameter for the first color component, wherein the first indicator has a first number of bits; and
when the CDEF is enabled for the second color component, parsing a second indicator indicating a CDEF parameter for the second color component, wherein the second indicator has a second number of bits, different than the first number of bits.

12. The method of claim 1, further comprising:
when the CDEF is enabled for the first color component, parsing a first indicator indicating a CDEF parameter for the first color component, wherein the CDEF parameter for the first color component has a first precision; and
when the CDEF is enabled for the second color component, parsing a second indicator indicating a CDEF parameter for the second color component, wherein the CDEF parameter for the second color component has a second precision, different than the first precision.

13. The method of claim 1, further comprising for a block in the current frame, determining whether the CDEF is enabled for the block by parsing a block-level syntax element that indicates whether to override the first frame-level syntax element.

14. The method of claim 13, wherein the block-level syntax element is conditionally signaled and parsed based on one or more attributes of the block.

15. The method of claim 1, further comprising determining a direction for the CDEF applied to the first color component based on a 4×4 block.

16. The method of claim 1, further comprising determining a unit size for the CDEF applied to the first color component.

17. A method of video encoding performed at a computing system having memory and one or more processors, the method comprising:
receiving video data comprising a plurality of frames, including a current frame;
signaling, via a video bitstream, a first frame-level syntax element indicating that a constrained directional enhancement filter (CDEF) is enabled for a first color component of the current frame;
signaling, via the video bitstream, a second frame-level syntax element indicating that the CDEF is not enabled for a second color component of the current frame; and
encoding the current frame.

18. The method of claim 17, wherein the first frame-level syntax element corresponds to a luma CDEF enablement flag, and wherein the second frame-level syntax element corresponds to a chroma CDEF enablement flag.

19. A non-transitory computer-readable storage medium storing a video bitstream that is generated by a video encoding method, the video bitstream comprising:
coded information for a plurality of frames including a current frame;
a first frame-level syntax element indicating that a constrained directional enhancement filter (CDEF) is enabled for a first color component of the current frame; and
a second frame-level syntax element indicating that the CDEF is not enabled for a second color component of the current frame.

20. The non-transitory computer-readable storage medium of claim 19, wherein the first frame-level syntax element corresponds to a luma CDEF enablement flag, and wherein the second frame-level syntax element corresponds to a chroma CDEF enablement flag.
